(19) United States
(12) Patent Application Publication
(10) Pub. No.: US 2002/0003972 A1
(43) Pub. Date: Jan. 10, 2002

(54) Device for positioning a cylinder sleeve on a supporting body

(76) Inventors: Christian Compera, Schoenau (DE); Gregory Kowalski, Victor, NY (US); James Shifley, Spencerport, NY (US)

Correspondence Address: Lawrence P. Kessler, Patent Department, NexPress Solutions LLC, 1447 St. Paul Street, Rochester, NY, 14653-7103, US

(21) Appl. No.: 09/858,110

(22) Filed: May 15, 2001

Related U.S. Application Data
(60) Provisional application No. 60/204,966, filed on May 17, 2000.

(30) Foreign Application Priority Data
May 17, 2000 (DE) 100 23 992.7

(51) Int. Cl. G03G 15/00

(52) U.S. Cl. 399/117

(57) ABSTRACT

The invention relates to a cylinder arrangement for electrographic printing units, having ends (4, 7) which are fitted to a supporting body (1) and on whose circumference there is supported a cylinder sleeve (6) whose outer face accommodates a functional layer (16). The cylinder arrangement (1, 4, 6, 7) contains devices (21, 25, 26, 27, 28, 29) for prepositioning the cylinder sleeve (6) when it is being replaced.

The present invention relates to a device for positioning a cylinder sleeve on a supporting body, in particular for positioning a cylinder sleeve with a functional layer, for example a photoelectric layer, accommodated on its outer face.

U.S. Pat. No. 5,215,013 relates to a device for damping noise when a sleeve-like rubber blanket is being pulled on the circumferential face of a printing-plate cylinder. This device is preferably used on the printing unit of an offset printing machine which is equipped with channel-less printing-unit cylinders. The blanket sleeve can be expanded in the circumferential direction, for which purpose the inner side of the blanket sleeve has a pressure applied to it which can be generated pneumatically. The expanded blanket sleeve is then pushed laterally in the manner of a telescope over the outer face of the cylinder. The blanket sleeve is provided with a damping ring to damp the noise which is caused by the compressed air emerging laterally. By means of the damping ring, the high-frequency noise produced by oscillations of the blanket sleeve, which is under pressure, is damped. At the location at which the blanket sleeve is fitted laterally to the cylinder outer to be pushed on, the cylinder outer face is provided with outlet openings which produce and maintain the air cushion as the blanket sleeve is pushed on over the outer face of the cylinder.

U.S. Pat. No. 5,649,267 relates to a cylinder arrangement which can be used in a printing unit. On the cylinder arrangement, which is of essentially drum-like design, use is made of an element which is configured to be essentially sleeve-like and on whose outer face a toner image is produced.

The drum outer face comprises open ends, whose ends are supported by the outer face of supporting, disk-like circumferential faces. The ends with which the openings of the cylindrically configured outer face can be closed are cooled down before being fitted, in order subsequently to be let into the openings in the outer face. The ends, which are shrunk into the cylinder outer face in this way, are in each case fitted with shaft bearings, in which a shaft which passes through the drum arrangement in the axial direction and is configured as a supporting body is accommodated. By means of setting screws provided at the ends, the eccentricity of the drum outer in relation to the axis of rotation can be preset.

In the case of electrographic printing units in which cylinders are used whose outer face is provided with a functional layer, for example a photoelectric layer, wear of the functional layer sets in, and makes their replacement necessary. In order to be able to make the replacement simply, the sleeve accommodating the functional layer is replaced inside or outside the printing unit; at the same time, it is necessary to push the cylinder sleeve bearing the functional layer on in the correct position.

In view of the solutions disclosed by the prior art and the technical problem indicated, the invention is based on the object of preventing canting or tilting of a sleeve bearing the functional layer as it is being mounted.

According to the invention, this object is achieved by the features of patent claim 1.

The advantages associated with the solution according to the invention can primarily be seen in the fact that, as a result of the prepositioning of the cylinder sleeve, on the one hand damage to the functional layer on the cylinder sleeve as a result of improper handling during the changing operation can be ruled out. On the other hand, tilting of the cylinder sleeve and its canting during the changing operation is ruled out. As a result of providing prepositioning, the cylinder sleeve can be changed in the horizontal position in the printing mechanism of a printing unit operating on the electrographic principle, it being possible for a minimum changeover time to be maintained.

In a further advantageous refinement of the idea on which the invention is based, provision is made for the devices for prepositioning the cylinder sleeve to make contact with the inner wall. This ensures that said cylinder sleeve is aligned, over its entire axial extent, in particular in the initial area where canting could have disadvantageous consequences, in such a way that it can be pushed on with strict axial alignment.

In addition, provision is made for the devices for prepositioning the cylinder sleeve to be fitted to a cylindrical element. The sleeve-like element, which can be designed in one or more parts, can be fitted in a simple way to a supporting body which passes through the cylinder arrangement, and is mounted on the supporting body such that it can be detached and thus easily replaced.

According to a further advantageous refinement of the idea on which the invention is based, the sleeve-like element can be mounted on the supporting body that passes through the cylinder arrangement. In addition to centering the sleeve-like element, and therefore the devices for prepositioning the cylinder sleeve, it is therefore also possible to replace the sleeve-like element easily.

According to a design variant of the devices for prepositioning the cylinder sleeve, these can also be designed to extend from the wall of the sleeve-like element as far as the inner wall of the cylinder sleeve to be positioned. In addition to increasing the rigidity of the cylinder arrangement which results after the cylinder sleeve has been drawn on axially, given a web-like design of the devices for prepositioning the cylinder sleeve, in addition to stiffening the cylinder arrangement, a significant saving in weight can also be achieved as compared with a solid design of the cylinder. The devices for prepositioning the cylinder sleeve can extend in the radial direction in relation to the supporting body, over its entire axial length. However, they can also be subdivided into individual sections and can be provided over the axial length of the supporting body or the sleeve-like element.

Simplifying the mounting of a cylinder body or its replacement may be achieved by the devices for prepositioning the cylinder sleeve being provided parallel to the axis of rotation of the supporting body. In this way, within the context of prepositioning, centering of the outer face of the cylinder sleeve can be achieved, the final centering being carried out by pretensioning the centering faces, provided with chamfers, that are provided at the ends; final centering in order to increase the accuracy can also be carried out by bracing the ends laterally with respect to each other.

According to one design variant, the devices for prepositioning the cylinder sleeve can make force-fitting contact with the inner wall of the cylinder sleeve. In addition to a force-fitting connection between the prepositioning devices that support the cylinder sleeve over its entire circumference, it would also be conceivable to produce a form-fitting connection between the end regions of the devices for prepositioning the cylinder sleeve, which extend essentially radially, and the inner wall of the cylinder sleeve, in the form of recesses that extend longitudinally, for example in the form of longitudinal grooves. Longitudinal grooves could be formed very simply in a particularly advantageous way on the inner face of the sleeve. Instead of longitudinal grooves, slot-like openings can also be formed in the inner wall of the cylinder sleeve, to whose surface the functional layer is applied in the form of an electrographic coating.

According to the presently proposed solution, a reduction in the weight of the proposed cylinder arrangement can be achieved in particular by cavities being created between the individual devices for prepositioning the cylinder sleeve, which extend in the radial direction in the manner of webs. As viewed over the overall circumference of the cylinder arrangement, it is possible, for example, for six radial walls of web-like design to be provided, being positioned at an angle of 60° in each case in relation to one another. Instead of the six webs formed here, as in the following exemplary embodiments, four or else eight webs oriented at 90° or 45° to one another, respectively, can also be formed in the interior of the drum.

In addition to section-by-section contact of the devices for prepositioning the cylinder sleeve, the web-like prepositioning devices can reach over the entire axial extent of the cylinder sleeve, whose axial extent corresponds exactly to the distance between the ends of the cylinder arrangement. In addition to continuous contact between the ends of the web-like devices for prepositioning the cylinder sleeve and the inner wall of the cylinder sleeve, bridge-like sections with individual interruptions in the direction of the axial extent of the cylinder sleeve can also be provided.

According to one design variant of the subject on which the invention is based, the outer face of the cylinder sleeve may be a photoelectric layer. The cylinder arrangement may be used, for example, for electrographic printing units, in which, following specific permissible wear of the surface of the functional layer, replacement of this layer is necessary. The printing units in which the cylinder arrangement proposed by the invention can be used can process web or sheet material, it being entirely possible for a number of cylinders with a replaceable cylinder sleeve to be provided in one printing unit.

The invention will be explained in more detail using the drawing, in which:

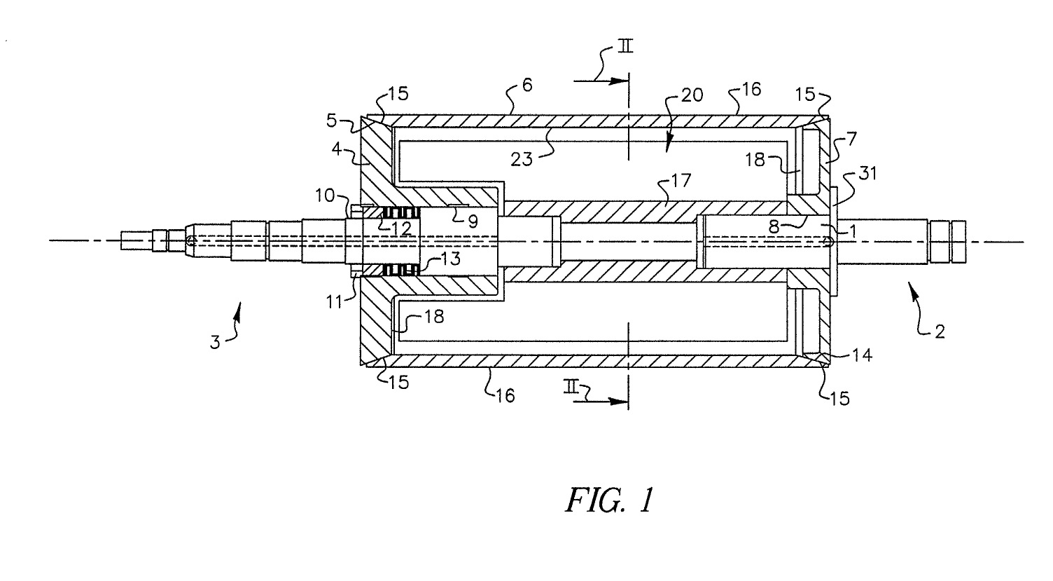

FIG. 1 shows a longitudinal section through a cylinder arrangement according to the present invention with a replaceable cylinder sleeve accommodating a functional layer, and

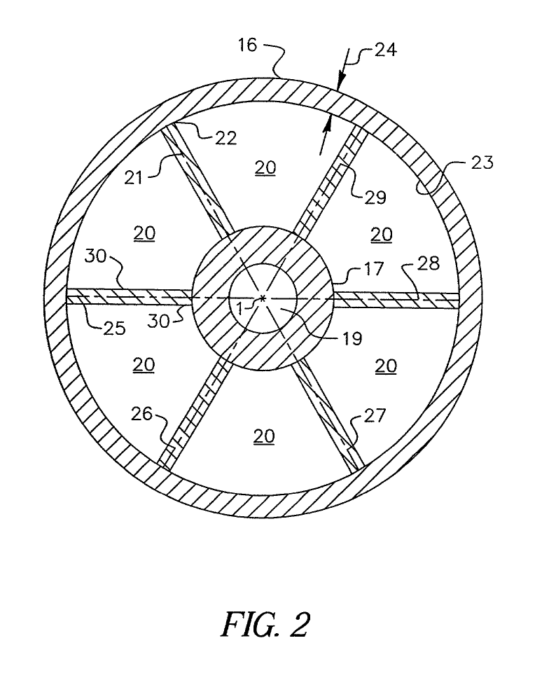

FIG. 2 shows a cross section through the cylinder arrangement according to FIG. 1.

In the longitudinal section through a cylinder arrangement according to the present invention which is illustrated in FIG. 1, a cylinder sleeve which accommodates a functional layer is positioned on two ends.

Formed on a supporting body 1, through which a bore passes and which extends essentially rotationally symmetrically with respect to its axis of rotation, are two bearing journals 2, 3. Mounted on the supporting body 1, in the area of seating faces, are a first end 4 and a second end 7. The end 7 is fixed in the axial direction on the supporting body 1 by a stop 31, while the first end 4 is fixed to its seating face on the circumference of the supporting body 1 by means of a detachable bracing means.

Formed on the ends 4 and 7, on the circumferential faces, are centering faces 5 which, in the illustration according to FIG. 1, can be designed as chamfers. In each case, the chamfers are oriented at an angle to the interior of the cylinder arrangement on the first end 4 and the second end 7. On the cylinder sleeve 6 which is to be fixed there, chamfers 15 are formed in a complementary fashion to the chamfers serving as centering faces 5 on the first end 4 and the second end 7. By means of the chamfers 5 and 15, the cylinder sleeve 6 can be fitted in a force fitting manner, via the positionable end 4, on the ends 4 and 7. Formed on the surface of the cylinder sleeve 6 is a functional layer 16, which may be a photoelectric layer, for example.

The first end 4, which can be positioned on the circumference of the supporting body 1 so as to be coaxial with the bearing journal 3, is secured by means of a slotted nut 11. The slotted nut 11, which can be rotated on a thread 10 formed on the bearing journal 3, acts on a pressure element 12 which, for its part, acts on a deformable sleeve 13 which is supported on an annular collar face on the supporting body 1. When the slotted nut 11 is rotated, the pressure element 12 is prestressed, and effects the deformation of the sleeve 13 in the radial direction. As a result, the first end 4 is detachably fixed at its seating face on the supporting body 1. Depending on the setting of the positionable first end 4 in relation to the second end 7, which is fixed in the axial direction, a degree of overlap 18 is established between the centering faces 5, 15. As a result, in particular eccentricity of the cylinder sleeve 6 and hence of the functional layer 16 may be adapted to the respective intended purposes.

Between the first end 4 and the second end 7, a sleeve 17 is mounted on the circumference of the supporting body 1. Formed on the periphery of the sleeve 17 are individual devices extending in the radial direction for prepositioning the cylinder sleeve 6.

The illustration according to FIG. 2 reveals a cross section through the cylinder arrangement according to FIG. 1. FIG. 2 shows the position of the sleeve 17 which is fitted to the circumference of the supporting body 1. The supporting body 1 is provided with lateral bearing journals 2 and 3, with which it is mounted in the side walls of a printing unit, either driven by means of a gear train or by a direct drive. From the circumference of the sleeve-like element 17, fitted to the circumference of the supporting body 1, and for this purpose provided with a screw hole 19, according to the illustration in FIG. 2, six web-like devices for prepositioning extend in the radial direction. These web-like devices for prepositioning 21, 25, 26, 27, 28 and 29, which extend, are positioned at an angle of about 60° in relation to one another and in each case enclose cavities 20 between them. Instead of the six devices for prepositioning extending in the radial direction as illustrated in FIG. 2, four web-like devices for prepositioning can also be provided, forming an angle of 90° with one another. In the case of a design of eight devices for prepositioning extending in the radial direction on the circumferential face of the sleeve 17, these form cavities at an angle of about 45° with one another. The arrangement of the devices for prepositioning, designed as a ribbed structure, has the advantage of stiffening the cylinder configuration according to FIG. 1 and is accompanied by a saving in weight. The tops of the respective web-like prepositioning devices 21, 25, 26, 27, 28 and 29 can be configured such that, in the initial region, they have a chamfer, on which the cylinder sleeve 6 can be positioned and pushed with lateral alignment onto the web-like elements. This can be done with the rear, second end 7 remaining in the machine, said end 7 being fixed to the supporting body 1 in its axial position. A chamfer on the respective prepositioning devices permits the cylinder sleeve 6, with the functional layer 16 formed thereon, to be pushed in the lateral direction without canting and tilting onto the second end 7 remaining in the printing machine.

Mounting the cylinder sleeve 6 is equally well possible given a lateral horizontal position of the supporting body 1 outside the printing unit. For this purpose, the supporting body 1, with the sleeve 17 fitted to it, has to be positioned in such a way that after the end 4 has been drawn off by relieving the load on the slotted nut 11, and after the associated relieving of stress on the pressure piece 10, the load on the deformable sleeve 13 is relieved, so that the first end 4 can be removed laterally from its seating face on the circumference of the supporting body 1 over the bearing journals 3. After the first end has been exposed and this component has been removed, the cylinder sleeve 6 can be drawn off laterally over the web-like elements 21, 25, 26, 27, 28 and 29, it being possible for the second end 7 to remain positioned in its axial position on the supporting body 1. The second end 7 is fixed axially at one end by the sleeve 17 provided on the circumference of the supporting body 1, and by the stop face 31.

After the cylinder sleeve 6 with the worn functional layer 16 has been removed, a cylinder sleeve 6 with a renewed functional layer 16 formed thereon can be positioned on the supporting body 1 again by being pushed on axially. For this purpose, the cylinder sleeve 6 is brought into the horizontal position by the devices for prepositioning the cylinder sleeve 6 and can then be pushed laterally onto the web-like prepositioning devices. After contact has been made between the centering faces 15 of the cylinder sleeve 6 and the centering faces 5 of the second end 7, and after the bracing of the first end 4 of the contact between the centering faces 5 and 15, and the setting of appropriate overlap areas 18 on the centering faces in the area of the ends, the first end is braced on its seating face on the supporting body 1 by means of the slotted nut 11 and the deformable sleeve 13. As a result, the eccentricity of the functional face 16 can be set with the maximum precision in relation to the axis of rotation of the supporting body 1.

Instead of the force-fitting prepositioning of the cylinder face 6 at its inner wall 23 with the end areas of the devices 21, 25, 26, 27, 28 and 29 in order to preposition the cylinder sleeve 6, a form-fitting connection between the prepositioning device and the inner wall 23 of the cylinder sleeve 6 can also be made. For this purpose, the inner wall 23 of the cylinder sleeve 6 can be provided, for example, with longitudinal grooves or slots extending in the axial direction. Point-like elevated portions and latching connections between the end areas of the prepositioning devices 21, 25, 26, 27, 28 and 29, which extend radially, and the inner wall 23 of the sleeve 6 are also conceivable.

The sleeve 17, to which the prepositioning devices 21, 25, 26, 27, 28 and 29 extending in the radial direction are fitted, can be produced from plastic or can be produced from plastics with metallic reinforcement. In addition, the material of which the cylinder sleeve 6, of wall thickness 24, consists can either be plastic with a metallic coating or a metallic sleeve. In order to save weight, the individual web faces 30 can be penetrated by apertures, in order to save weight and material. Instead of a continuous bearing face at the radial end of the prepositioning devices 21, 25, 26, 27, 28 and 29, these can also make contact with the inner wall 23 of the cylinder sleeve 6 only in sections, so that free areas remain between the individual end areas making contact with the wall 23. Using a configuration composed in this way, which is not specifically illustrated in the drawing here, in addition to a stiffening action, a saving in weight of a cylinder arrangement composed in this way can also be achieved.

### Part List

1 Supporting body

2 Bearing journal

3 Bearing journal

4 First end

5 Centering face of end

6 Cylinder sleeve

7 Second end

8 Seating face

9 Seating face

10 Thread

11 Slotted nut

12 Pressure element

13 Deformable sleeve

14 Centering face of ends

15 Centering faces of sleeve

16 Functional layer

17 Sleeve

18 Overlap area

19 Throughbore

20 Cavity segment

21 Positioning web

22 Positioning face

23 Inner wall of cylinder sleeve

24 Wall thickness

25 Web

26 Web

27 Web

28 Web

29 Web

30 Face

31 Stop

What is claimed is:

1. A cylinder arrangement for electrographic printing units, having ends (4, 7) which are fitted to a supporting body (1) and on whose circumference there is supported a cylinder sleeve (6) whose outer face accommodates a functional layer (16), wherein the arrangement (1, 4, 6, 7) contains devices (21, 25, 26, 27, 28, 29) for prepositioning the cylinder sleeve (6) when it is being replaced.

2. The cylinder arrangement as claimed in claim 1, wherein the devices (21, 25, 26, 27, 28, 29) for prepositioning the cylinder sleeve (6) make contact with its inner wall (23).

3. The cylinder arrangement as claimed in claim 1, wherein the prepositioning devices (21, 25, 26, 27, 28, 29) permit the adequate centering of the cylinder sleeve per Se.

4. The cylinder arrangement as claimed in claim 1, wherein the devices (21, 25, 26, 27, 28, 29) for prepositioning the cylinder sleeve (6) are fitted to a sleeve-like element (17).

5. The cylinder arrangement as claimed in claim 4, wherein the sleeve-like element (17) is fitted to the supporting body (1) that passes through the cylinder arrangement (1, 4, 6, 7).

6. The cylinder arrangement as claimed in claim 1, wherein the devices (21, 25, 26, 27, 28, 29) for prepositioning the cylinder sleeve (6) extend from the wall of the sleeve-like element (17) as far as the inner wall (23) of the cylinder sleeve (6) to be positioned.

7. The cylinder arrangement as claimed in claim 1, wherein the devices (21, 25, 26, 27, 28, 29) for prepositioning the cylinder sleeve (6) are designed like webs.

8. The cylinder arrangement as claimed in claim 7, wherein the devices (21, 25, 26, 27, 28, 29) extend in the radial direction from the supporting body (1).

9. The cylinder arrangement as claimed in claim 1, wherein the devices (21, 25, 26, 27, 28, 29) for prepositioning the cylinder sleeve (6) extend parallel to the axis of rotation of the supporting body (1).

10. The cylinder arrangement as claimed in claim 1, wherein the devices (21, 25, 26, 27, 28, 29) for prepositioning the cylinder sleeve (6) make force-fitting contact with its inner wall (23).

11. The cylinder arrangement as claimed in claim 1, wherein the devices (21, 25, 26, 27, 28, 29) for prepositioning the cylinder sleeve (6) engage in recesses in the inner wall (23) of the cylinder sleeve (6).

12. The cylinder arrangement as claimed in claim 10, wherein the recesses are formed as longitudinal grooves in the inner wall (23) of the cylinder sleeve (6).

13. The cylinder arrangement as claimed in claim 1, wherein cavities (20) are formed between the devices (21, 25, 26, 27, 28, 29) for prepositioning the cylinder sleeve (6).

14. The cylinder arrangement as claimed in claim 1, wherein the axial extent of the devices (21, 25, 26, 27, 28, 29) for prepositioning the cylinder sleeve (6) corresponds to the distance between the ends (4, 7) of the cylinder arrangement (1, 4, 6, 7).

15. The cylinder arrangement as claimed in one or more of the preceding claims, wherein the outer face (16) of the cylinder sleeve (6) is a photoelectric layer.

16. A cylinder arrangement for electrographic printing units, having ends (4, 7) which are fitted to a supporting body (1) and on whose circumference there is supported a cylinder sleeve (6) whose outer face is formed as a photoelectric layer (16), wherein the cylinder arrangement (1, 4, 6, 7) contains devices (21, 25, 26, 27, 28, 29) for prepositioning the cylinder sleeve (6) when it is being replaced.

17. A printing mechanism having a cylinder arrangement for electrographic printing, having ends (4, 7) that are fitted to a supporting body (1) and on whose circumference there is supported a cylinder sleeve (6) whose outer face accommodates a functional layer (16), wherein the cylinder arrangement (1, 4, 6, 7) contains devices (21, 25, 26, 27, 28, 29) for prepositioning the cylinder sleeve (6) when it is being replaced.

18. A printing unit for processing sheet or web printing materials, having a cylinder arrangement for electrographic printing, having ends (4, 7) which are fitted to a supporting body (1) and on whose circumference there is supported a cylinder sleeve (6) whose outer face accommodates a functional layer (16), wherein the cylinder arrangement (1, 4, 6, 7) contains devices (21, 25, 26, 27, 28, 29) for prepositioning the cylinder sleeve (6) when it is being replaced.
